(19) United States
(12) Patent Application Publication
(10) Pub. No.: US 2010/0299435 A1
(43) Pub. Date: Nov. 25, 2010

(54) COMMUNICATION DEVICE, CONTROL METHOD FOR COMMUNICATION DEVICE, AND STORAGE MEDIUM

(75) Inventor: Fumihide Goto, Naka-gun (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/842,774

(22) Filed: Jul. 23, 2010

Related U.S. Application Data
(63) Continuation of application No. PCT/JP2009/059349, filed on May 21, 2009.

(51) Int. Cl. G06F 15/173

(52) U.S. Cl. 709/225

(57) ABSTRACT

[Object] To enable a device that is a target for denial of communication to be shared over a network.

[Solution] A communication device registers identifying information of a denial target device that is present in a first network and that is a target for denial of communication and notifies another device of the registered identifying information of the denial target device. The communication device constructs a second network different from the first network with the other device.

This application is a Continuation of International Application No. PCT/JP2009/059349, filed May 21, 2009, which is hereby incorporated by reference herein in its entirety.

### TECHNICAL FIELD

The present invention relates to a communication device, a control method for a communication device, and a storage medium.

### BACKGROUND ART

In recent years, more and more home electrical appliances have been network-enabled, and they are increasingly used in a way in which their communication apparatuses with the wireless local area network (LAN) function communicate with each other without through base stations.

For wireless LAN devices conforming to the IEEE 802.11 series standard, there are ad-hoc network specifics called the independent basic service set (IBSS) for directly connecting the devices. With an ad-hoc network, all communication apparatuses are in equal relationship, and typically, if communication parameters are correctly set, relevant communication apparatuses can be readily connected to each other.

One example method for limiting communications between communication apparatuses is the one by specifying an address, such as a MAC address, of a partner and filtering a received packet. For an infrastructure network between a wireless base station and a wireless child station, there is a mechanism in which a MAC address corresponding to a connection that should be denied is specified in a base station to limit a connection of a child station (see, for example, Patent Literatures 1 and 2).

A function of easily setting communication parameters between a wireless base station and a wireless child station (Wi-Fi protected setup (WPS)) is proposed by the Wi-Fi Alliance, which is the industry standard group (see, for example, Non Patent Literature 1).

When communication apparatuses having the wireless LAN function directly communicate with each other without through a wireless base station, an ad-hoc network is used in many cases. For an ad-hoc network, if communication parameters of communication apparatuses match with each other, they can communicate, so convenience is high. The communication parameters can be readily set by the use of the above-described WPS.

To prohibit a specific communication apparatus from participating in a network, for an infrastructure network, because communication is carried out through a base station, denial of connection, such as filtering setting using MAC addresses, can be set in the base station. However, for an ad-hoc network, communication is not carried out through a specific apparatus, such as a base station. Accordingly, denial of connection, such as filtering setting using MAC addresses, needs to be set for all communication apparatuses, so the operation is complicated.

Even when denial of connection is set in a base station, if communication parameters are set by communication apparatuses using a simple communication parameter setting technique, such as WPS, an apparatus that should not communicate may easily communicate.

Patent Literature 1: Japanese Patent Laid-Open No. 2003-204338

Patent Literature 2: Japanese Patent Laid-Open No.

Non Patent Literature 1: Wi-Fi CERTIFIED™) for Wi-Fi Protected Setup Easing the User Experience for Home and Small Office Wi-Fi(R) Networks, http://www.wifi.org/wp/wifi-protected-setup

### SUMMARY OF INVENTION

It is an object of the present invention to enable a device that is a target for denial of communication to be shared over a network.

The present invention can provide a communication device. The communication device includes a registering unit that registers identifying information of a denial target device that is present in a first network and that is a target for denial of communication, a notifying unit that notifies another device present in the first network of the identifying information of the denial target device registered by the registering unit, and a constructing unit that constructs with the other device, a second network different from the first network in which the denial target device is present.

Further features of the present invention will become apparent from the following description of exemplary embodiments with reference to the attached drawings.

### BRIEF DESCRIPTION OF DRAWINGS

FIGS. 1A and 1B are device configuration diagrams according to embodiments.

FIG. 2 is a network configuration diagram according to a first embodiment and a third embodiment.

FIG. 3 is an operational sequence diagram according to the first embodiment.

FIG. 4 is an operational sequence diagram for a device A according to the first embodiment.

FIG. 5 is an operational flow chart for a device B or a device C according to the first embodiment.

FIG. 6 is an operational sequence diagram according to the first embodiment.

FIG. 7 is an operational flow chart for the device A according to the first embodiment.

FIG. 8 is a network configuration diagram according to a second embodiment.

FIG. 9 is an operational sequence diagram according to the second embodiment.

FIG. 10 is an operational sequence diagram for the device A according to the second embodiment.

FIG. 11 is an operational sequence diagram according to the second embodiment.

FIG. 12 is an operational sequence diagram according to the third embodiment.

FIG. 13 is an operational flow chart for a communication device according to the third embodiment.

### DESCRIPTION OF EMBODIMENTS

### First Embodiment

Communication devices according to the present embodiment are described in detail with reference to the drawings. In the following description, an example that uses a wireless LAN system conforming to the IEEE 802.11 series is described. However, communication forms are not necessarily limited to an IEEE 802.11 compliant wireless LAN.

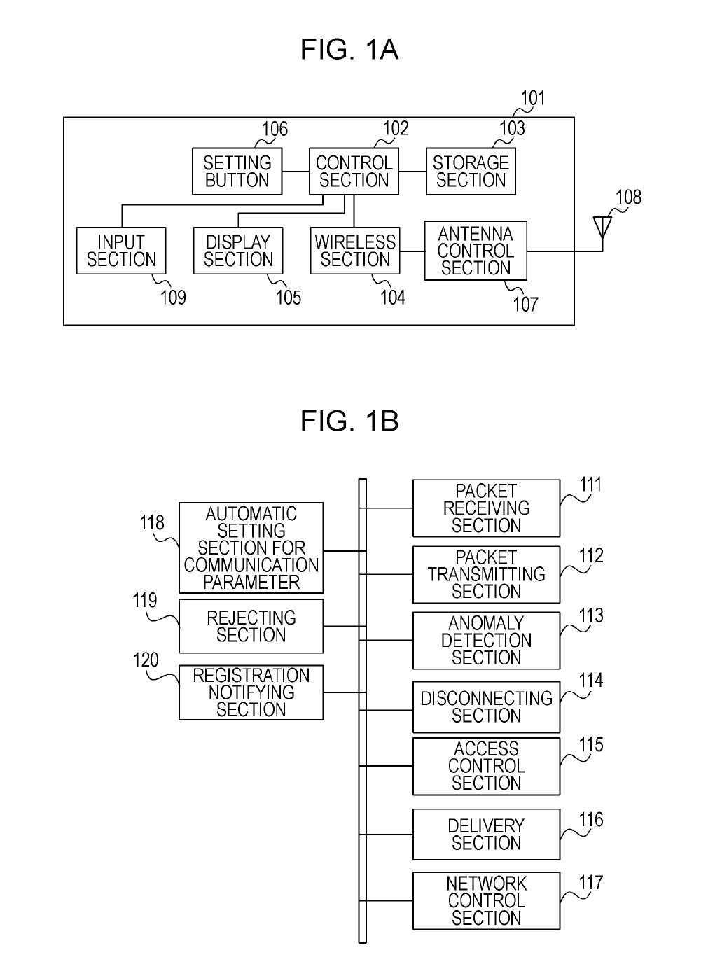

FIGS. 1A and 1B are block diagrams that illustrate an example configuration of each device described below according to an embodiment to which the present invention is applicable. FIG. 1A illustrates an example of a hardware configuration, and FIG. 1B illustrates an example of a software configuration of functional blocks. Reference numeral 101 in FIG. 1A indicates a whole device. Reference numeral 102 indicates a control section that exercises control over the device by executing a control computer program stored in a storage section 103. The control section 102 also controls setting of a communication parameter between its own device and another device. Reference numeral 103 indicates a storage section that stores the control program executable by the control section 102 and various kinds of information, such as a communication parameter. Various kinds of operation described below are performed by the control section 102 executing the control program stored in the storage section 103. Reference numeral 104 is a wireless section for carrying out wireless LAN communication conforming to the IEEE 802.11 series. Reference numeral 105 indicates a display section that displays various kinds of information and has the function of being able to output visually recognizable information, like a liquid crystal display (LCD) or light emitting diode (LED), or to produce audio output, like a speaker. The display section 105 has the function of outputting at least one of visual information and audio information.

Reference numeral 106 indicates a setting button for providing a trigger for starting a communication parameter setting process. When the setting button 106 is operated, a process for automatically setting a communication parameter is started. When detecting an operation on the setting button 106 by a user, the control section 102 performs a process described below. Reference numeral 107 indicates an antenna control section, and reference numeral 108 indicates an antenna. Reference numeral 109 indicates an input section for receiving various inputs from a user.

Reference numeral 111 in FIG. 1B indicates a packet receiving section that receives a packet relating to various kinds of communication. Reference numeral 112 indicates a packet transmitting section that transmits a packet relating to various kinds of communication. Reference numeral 113 indicates an anomaly detection section and detects anomaly occurring in a communication partner device. When a security problem occurs in a communication partner, the anomaly detection section 113 detects that problem. For example, the anomaly detection section 113 detects that a communication partner is the sender of a denial-of-service (Dos) attack or detects infection with a computer virus. The anomaly detection section 113 detects, as anomaly, that communication with a communication partner hampers communication with another device and the existence of the device interferes with a communication band. The anomaly detection section 113 also detects failure of a communication partner as anomaly. In addition, when a communication partner performs an operation opposing a network policy or when denial of connection is set by a user's intension (operation), the anomaly detection section 113 also detects it as anomaly.

Reference numeral 114 indicates a disconnecting section that disconnects the connection to a communication partner. To disconnect a communication partner, the disconnecting section 114 transmits a disconnection notification to the partner and disconnects the partner. When receiving a disconnection notification from a communication partner, the disconnecting section 114 disconnects the connection to the device of the sender of the disconnection notification. Reference numeral 115 indicates an access control section, and the function of controlling permission and non-permission of wireless communication, such as MAC address filtering described below, is performed by the access control section 115. MAC address information that is identifying information about a communication device being a target for denial of communication to be filtered is retained in a deny MAC address list in the storage section 103. Reference numeral 116 indicates a delivery section and delivers the deny MAC address list stored in the storage section 103 to another device. The delivery section 116 receives a deny MAC address list delivered from another device. The access control section 115 updates a previously stored deny MAC address list on the basis of the deny MAC address list received by the delivery section 116.

Reference numeral 117 indicates a network control section that exercises various kinds of network control, such as wireless LAN network establishment and a process for connecting to a network. Reference numeral 118 indicates an automatic setting section for a communication parameter being network information. For the present embodiment, a communication parameter necessary for wireless LAN communication, such as a subsystem identification (SSID) as a network identifier, an encryption method, an encryption key, an authentication method, or an authentication key, is automatically set. In the following description, automatic setting of a communication parameter is simply referred to as automatic setting. The automatic setting section 118 performs a process required for determining a management device for a network, a process for providing a communication parameter to another device, or a process required for receiving a provided communication parameter. A process for sharing a communication parameter (providing process, receiving process) is performed by execution of a predetermined communication protocol between devices. When detecting an operation on the setting button 106 by a user, the automatic setting section 118 starts various processes.

These functional blocks have software or hardware correlation. The above-described functional blocks are an example. A plurality of functional blocks may form a single functional block. A functional block may be divided into blocks performing a plurality of functions.

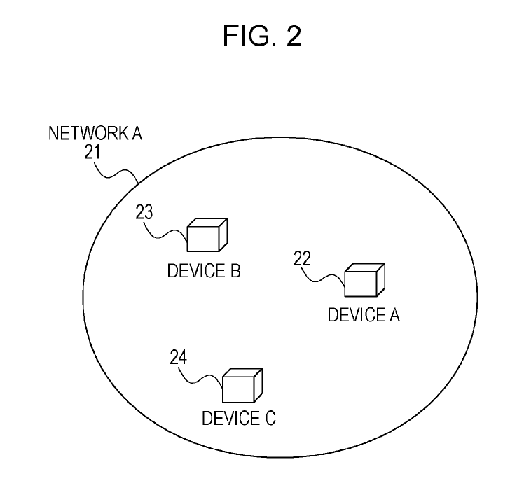

FIG. 2 illustrates a communication device A 22 (hereinafter device A), a communication device B 23 (hereinafter device B), a communication device C 24 (hereinafter device C), and a network A 21 (hereinafter network A). These communication devices have the configuration illustrated in FIG. 1. The device A is a management device for the network A. The network control section 117 of the device A establishes a network. The device B and device C are connected to the device A.

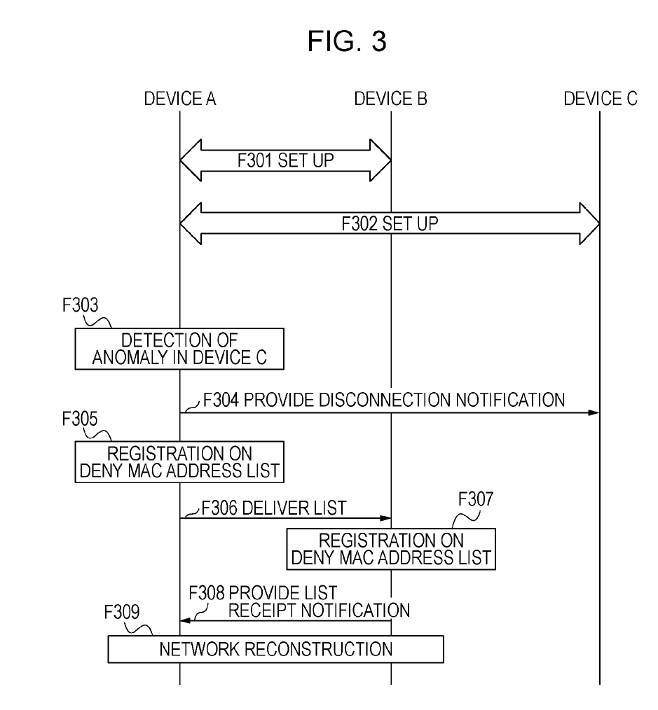

FIG. 3 is a sequence diagram that illustrates an example in which the setting button 106 of each of the device A, device B, and device C is pressed, a process for automatically setting a communication parameter is performed between the devices, the devices are connected to each other, and then, a problem occurs in the device C and the device A separates the device C.

The setting button 106 of each of the device A and device B is pressed by a user. This causes a process for setting up wireless LAN to be performed between the device A and device B (F301). In the wireless LAN set-up process, the device A is determined to operate as a management device for the network A. Then, a process performed by the automatic setting section 118 supplies a communication parameter from the device A to the device B, and the communication parameter is shared by the device A and device B. After the completion of the set-up, the device B becomes connected to the device A.

When a press on the setting button 106 of each of the device A and device C is detected, a process for setting up wireless LAN is also performed between the device A and device C (F302). As in the case of the device A and device B, after the completion of the set-up, the device C becomes connected to the device A. Also while the device A and the device C are performing the set-up, the device B can still communicate with the device A.

It is assumed that, after the network A that is a first network is constructed from the device A, device B, and device C, the anomaly detection section 113 of the device A detects anomaly in the device C (F303). The anomaly detection section 113 detects a security problem, detects that communication with the device C hampers communication with another device and the existence of the device C interferes with a communication band, or detects device failure. The detection of a security problem include detection that the device C is the sender of a denial-of-service (Dos) attack or detection of infection with a computer virus. Also when the device C performs an operation opposing a network policy of the network A, the anomaly detection section 113 detects it as anomaly. Also when denial of connection is set by a user's intension (operation), the anomaly detection section 113 detects it as anomaly.

The device A having detected anomaly transmits a disconnection notification to the device C from the disconnecting section 114 to separate the device C from the network A and disconnects the device C (F304). The access control section 115 of the device A having separated the device C from the network A registers the MAC address of the device C on a deny MAC address list in the storage section 103 (F305). The deny MAC address list is a list that manages a MAC address of a device that is a target of MAC address filtering by which the device A does not permit wireless communication.

The device A having updated the deny MAC address list delivers the deny MAC address list to a subordinate communication device (device B in the present embodiment) from the delivery section 116 (F306). The deny MAC address list to be delivered may have all MAC addresses corresponding to connections denied by the device A, or alternatively, may have only an added, changed, or deleted MAC address.

The access control section 115 of the device B having received the deny MAC address list from the device A registers the MAC address of the device C on the deny MAC address list in the storage section 103 (F307). To make notification that the deny MAC address list has been properly received, a notification of receipt of the list is transmitted to the device A (F308).

The device A having received the list receipt notification reconstructs the network A that is a second network by using the network control section 117 (F309). At this time, a new network that does not contain the device C is established. Only the deny MAC address list may be simply updated without reconstruction of the network. That is, reconstruction of the network is optional. However, because a MAC address may be tampered with, the network may preferably be reconstructed.

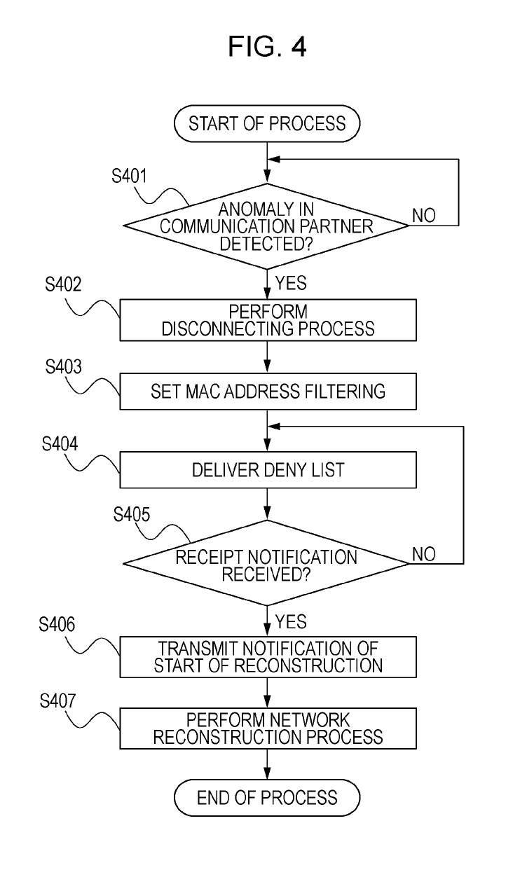

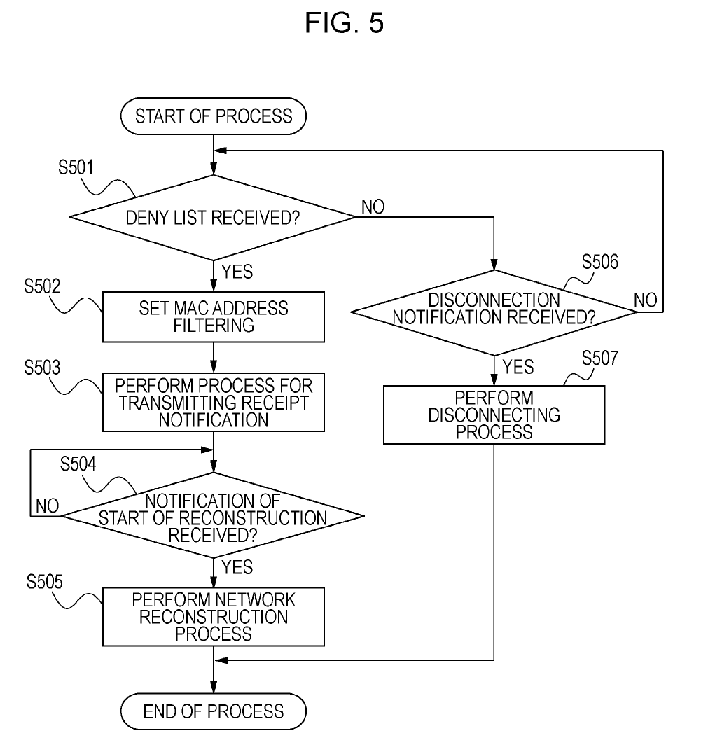

FIG. 4 is a flowchart for describing a process by the device A, and FIG. 5 is a flowchart for describing a process by the device B and device C. These processes are performed by the control section 102 reading a control program from the storage section 103 and executing it. In FIG. 4, wireless LAN set-up is omitted. That is, FIG. 4 is an operational flow diagram that illustrates F303 and its subsequent operations in FIG. 3.

The communication device (device A) determines whether anomaly in a communication partner device has been detected by the anomaly detection section 113 (S401). When the anomaly detection section 113 has detected anomaly, the disconnecting section 114 transmits a disconnection notification toward the communication device in which anomaly has been detected (device C in the present embodiment) and performs a disconnecting process for disconnecting the connection (S402). After that, the access control section 115 registers the MAC address of the communication device determined to be anomalous (device C in the present embodiment) on the deny MAC address list in the storage section 103 and sets (updates) the MAC address filtering (S403). This setting rejects communication with the communication device determined to be anomalous (device C in the present embodiment).

After the deny MAC address list is updated, the delivery section 116 delivers the list to a subordinate communication device (device B in the present embodiment) (S404). After delivering the list, the delivery section 116 determines whether a receipt notification has been received from all recipient communication devices (S405). In the present embodiment, the delivery target communication device is only one communication device B; in the case of a large-scale network, there is a plurality of delivery target communication devices, and the delivery section 116 delivers the list to the plurality of devices. When not all receipt notifications have been received from the recipients after a lapse of a specified period of time, flow returns to S404 and the deny MAC address list is delivered again. The retransmitting process here may be performed on only a communication device from which no receipt notification has been received or may be performed on all communication devices.

When a receipt notification has been received from all communication devices to which the list was delivered, the network control section 117 transmits a start notification for starting a network reconstruction process to the network (S406). After that, the network control section 117 reconstructs the network (S407). The network reconstruction can be achieved by performing wireless LAN set-up again after the notification of the start of the network reconstruction is transmitted. Alternatively, a technique of delivering a plurality of communication parameters in the initial wireless LAN set-up (F301), specifying a communication parameter to be used in providing the reconstruction notification in S406, and switching to the specified communication parameter may also be used.

Operations of the device B and device C are described on the basis of FIG. 5. In FIG. 5, wireless LAN set-up is omitted, as in the FIG. 4, and it is assumed that a network has already been established.

The communication device (device B or C) determines whether the deny MAC address list has been received by the delivery section 116 (S501). When no list has been received, the communication device determines whether a disconnection notification has been received by the disconnecting section 114 (S506). When no disconnection notification has been received, flow returns to step S501. For the present embodiment, the device B receives the deny MAC address list, whereas the device C receives the disconnection notification.

The access control section 115 of the device B having received the deny MAC address list in S501 additionally sets the listed MAC addresses corresponding to communication to be denied in its own MAC address filtering function (S502). After the completion of the setting of the MAC address filtering, the access control section 115 transmits a receipt notification to the sender of the deny MAC address list (S503). After the transmission of the receipt notification, a notification of the start of network reconstruction is transmitted from the device A. The network control section 117 of the device B determines whether the start notification of the start of network reconstruction has been received (S504).

When the start notification of the reconstruction has been received, the network reconstruction is performed (S505). The network reconstruction can be achieved by performing wireless LAN set-up again after the notification of the start of the network reconstruction is transmitted. Alternatively, a technique in which a plurality of communication parameters is delivered in the initial wireless LAN set-up (F301), a communication parameter to be used is specified when the network reconstruction notification is provided in S504, and the communication parameter switches to the specified communication parameter may also be used. The disconnecting section 114 of the device C having received the disconnection notification in S506 performs a disconnecting process for disconnecting the connection to the device A (S507).

Next, a process occurring after registration on the deny MAC address list and disconnection of the communication device is described.

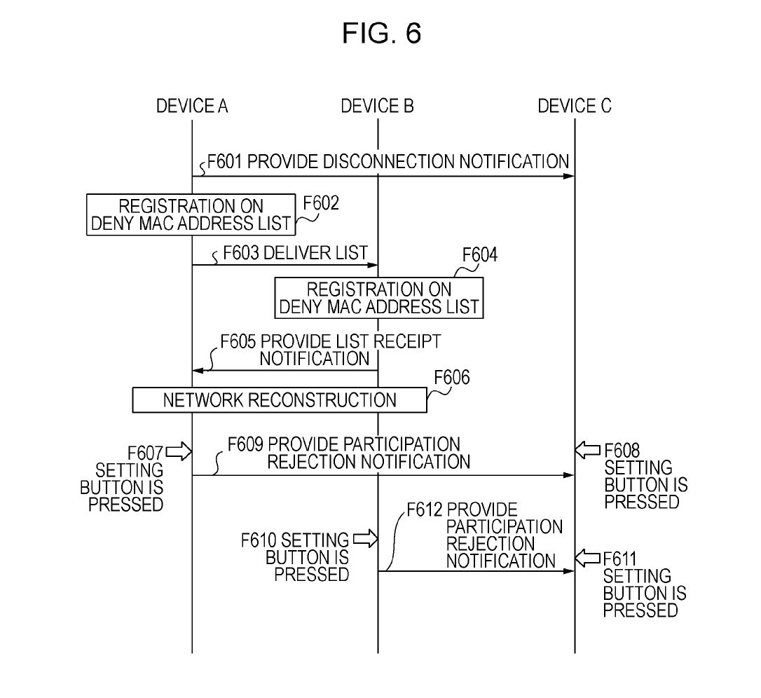

FIG. 6 is a sequence diagram that illustrates an example in which a problem occurs in the device C of the device A, device B, and device C, the device A separates the device C, and then the setting button 106 of each of the devices is operated.

When the network A made up of the device A, device B, and device C is established, some anomaly occurs in the device C and the disconnecting section 114 of the device A transmits a disconnection notification toward the device C (F601). The access control section 115 of the device A having separated the device C registers the MAC address of the device C on the deny MAC address list in the storage section 103 (F602). The delivery section 116 of the device A delivers the deny MAC address list to a subordinate communication device (device B in the present embodiment) (F603). The access control section 115 of the communication device (device B) having received the deny MAC address list registers the MAC address of the device C on the deny MAC address list in the storage section 103 on the basis of the received list (F604). Then, a notification of receipt of the list is transmitted (F605). A new network is established with communication devices (device A and device B in the present embodiment) other than the communication device in which anomaly occurred (F606).

Here, it is assumed that, after the network is reconstructed, the setting button 106 of each of the device A and device C is operated by a user, and the operation is detected (F607, F608). For the device A, the deny MAC address list registered in F602 is effective, so a rejecting section 119 of the device A transmits a notification of rejection of participation toward the device C and rejects new participation by the device C (F609). When the operation on the setting button 106 is detected, the automatic setting section 118 exchanges signals between devices to perform a process required for searching for a partner device, a process required for determining a network management device, or a process required for providing or receiving a communication parameter. Each of the signals is the one in which the MAC address of the sender of the signal is added. In the searching process, the management device determining process, or the communication parameter automatic setting process performed by the automatic setting section 118, the access control section 115 checks whether the MAC address added to the received signal has been registered on the deny MAC address list. When a device registered on the deny MAC address list has requested a process required for determining a management device or when that device has requested providing a communication parameter, the rejecting section 119 transmits a notification of rejection of participation to the requester. The device A does not perform the process of determining a management device and the process of providing a communication parameter with a device whose participation has been rejected.

Next, a case in which the setting button 106 of each of the device B and device C is operated (F610, F611) is discussed.

In this case, because the deny MAC address list having the same content as that retained in the device A is set in the device B, the rejecting section 119 of the device B rejects new participation by the device C, as in the case of the device A and device C. Accordingly, a notification of rejection of participation is transmitted from the device B toward the device C (F612).

As described above, if a communication device registered on the deny MAC address list attempts to perform set-up again, the connection is rejected and the communication device becomes unable to communicate with a device participating in the network A.

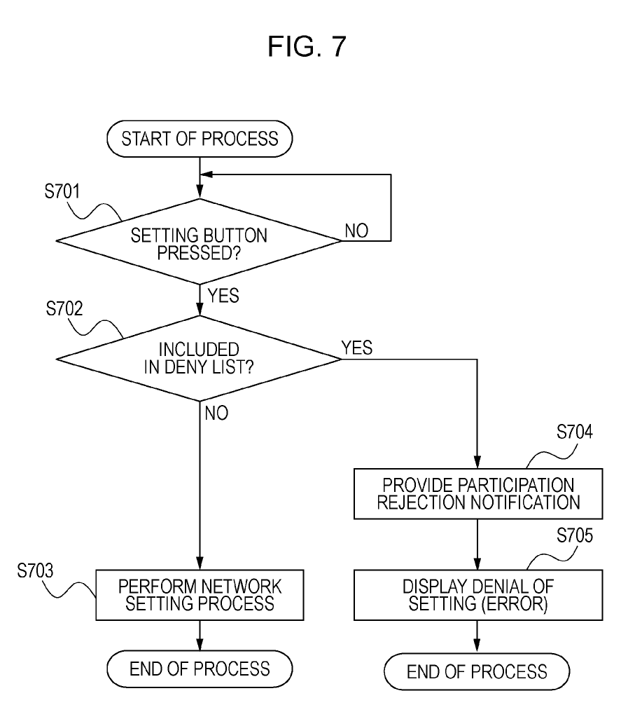

A process by the device A and device B is described on the basis of FIG. 7. The process is also performed by the control section 102 reading a control program from the storage section 103 and executing it. An operation on the setting button 106 is detected in a communication device (S701). When the operation on the setting button 106 is detected, the automatic setting section 118 starts an automatic setting process for a communication parameter. To perform the automatic setting process with a partner device, a packet for the setting process is received. The access control section 115 determines whether the MAC address of the partner device is included in the deny MAC address list (S702). When the partner device is not included in the deny MAC address list, the automatic setting section 118 performs a network setting process (set-up process) for performing a process for determining a management device and a process for providing or receiving a communication parameter is performed (S703).

When the partner device (device C in the present embodiment) is included in the deny MAC address list, the rejecting section 119 transmits a notification of rejection of participation toward the partner (device C) (S704), the automatic setting process for a communication parameter with the partner is disabled. Then, the rejecting section 119 displays denial of setting (error) on the display section 105 to notify a user of denial of execution of the automatic setting (S705).

One example method to cancel the state of rejecting participation is automatic cancellation at the time the anomaly detected in F303 is removed. Alternatively, the cancelling process may be explicitly performed by an operation of a user.

As described above, when a certain device performs setting of separating a specific device, another device can reflect the setting. As a result, the device separated from the network can be prevented from participating in the network via a different route (through a different device). Reconstructing the network with another device after the specific device is separated from the network can prevent the separated device from reconnecting. Even if an operation of automatically setting a communication parameter is performed in a device separated from a network, an automatic setting process with that device can be disabled and reconnection can be prevented. If an automatic setting process is not performed, a user is notified that the setting has been rejected because the partner is a target for denial of connection, so operability (usability) can be improved.

When anomaly in a communication device being a communication partner is detected, that device can be separated from the network. At the same time, information about the device in which anomaly has been detected can be delivered to another device of the network, and re-setting and reconnecting can be prohibited. These advantages are particularly effective for a system in which communication devices directly communicate with each other without through a base station.

### Second Embodiment

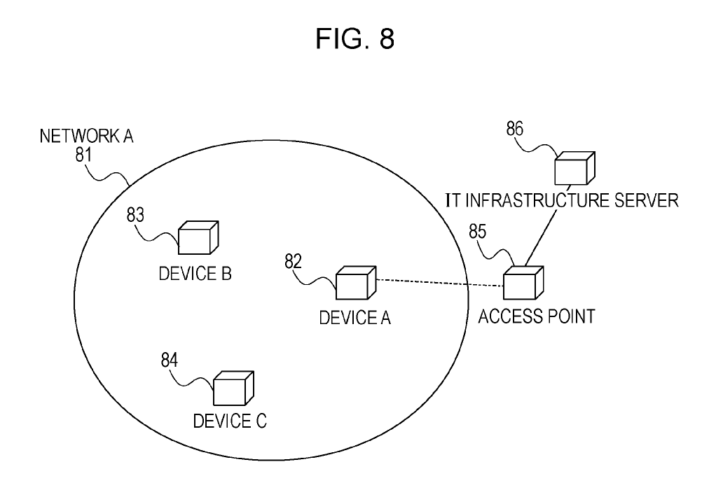

FIG. 8 illustrates a communication device A 82 (device A), a communication device B 83 (device B), a communication device C 84 (device C), a network A 81 (network A), an access point 85 (AP), and an IT infrastructure server 86 (infrastructure server). The device A, device B, and device C have the configuration illustrated in FIG. 1 described in the first embodiment.

The infrastructure server manages a network connection policy and is a server that performs apparatus authentication of a communication apparatus that aims to connect to a network and user authentication. When the device A is connected to the AP through wireless LAN, wired LAN, or the like, a device that aims to connect to the device A is subjected to an authentication process by the infrastructure server.

The device A is a management device for the network A. The device B and device C are connected to the device A. The device A is further connected to the AP, and the device A and the AP are managed by the infrastructure server. That is, the network A with the centered device A is under control of the infrastructure server. Each of the device B and device C performs wireless LAN set-up between itself and the device A. The device A is a management device for the network A and establishes the network A containing the device B and device C.

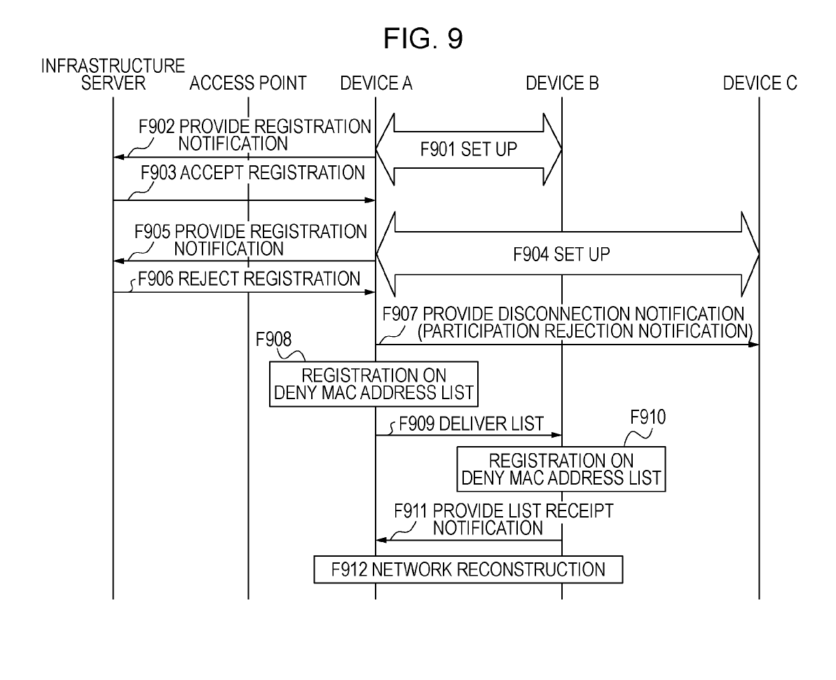

FIG. 9 is a sequence diagram that illustrates an example in which, in a state where the device A is connected to the AP, when an automatic setting process is performed between the devices and connecting is attempted, because the device C has a problem, the device A separates the device C.

A press on the setting button 106 is detected in each of the device A and device B. This causes a process for setting up wireless LAN to be performed between the device A and device B (F901). In the wireless LAN set-up process, the device A is determined to operate as a management device for the network A.

During the set-up process or after the completion of the set-up process, a registration notifying section 120 of the device A provides the infrastructure server with a notification of existence of a communication device that attempts to newly participate in the network A (F902). This notification is transmitted from the registration notifying section 120 of the device A toward the infrastructure server such that information about the device B is added to a registration notification signal. Examples of the information about the device B include the MAC address of the device B, device type (kind), and functions. Alternatively, during the set-up process or after the completion of the set-up process, the device A may receive authentication information, such as a password, from the device B, and the infrastructure server may be notified of this authentication information.

The infrastructure server having received the registration notification (F902) determines on the basis of a network policy retained by the infrastructure server whether the device B is permitted to participate in the network A or not. When determining to accept participation by the device B in the network, the infrastructure server transmits a notification of acceptance of registration toward the device A (F903).

Because the device A is determined to operate as the management device for the network A, when the device B requests connecting, the device A having received the registration acceptance notification permits the connection of the device B. Examples of the network policy used here include whether the device B is registered in advance in the infrastructure server and whether the security function of the device B matches with the security policy of the infrastructure server. The network policy may be success or failure of authentication using authentication information, such as a password.

Then, a wireless LAN set-up process is performed between the device A and device C (F904). While the device A and device C are performing the set-up, the device B can communicate with the device A. In the wireless LAN set-up process, the device A is determined to operate as a management device for the network A.

During the set-up process or after the completion of the set-up process, the registration notifying section 120 of the device A provides the infrastructure server with a notification of existence of a communication device that attempts to newly participate in the network A (F905). This notification is transmitted from the registration notifying section 120 of the device A toward the infrastructure server such that information about the device C is added to a registration notification signal. Examples of the information about the device C include the MAC address of the device C, device type (kind), and functions. Alternatively, during the set-up process or after the completion of the set-up process, the device A may receive authentication information, such as a password, from the device C, and the infrastructure server may be notified of this authentication information.

The infrastructure server having received the registration notification (F905) determines on the basis of the network policy retained by the infrastructure server whether the device C is permitted to participate in the network A or not. When determining not to accept participation by the device C in the network, the infrastructure server transmits a notification of rejection of registration toward the device A (F906).

The disconnecting section 114 of the device A having received the notification of rejection of registration transmits a disconnection notification (or the rejecting section 119 transmits a notification of denial of participation) toward the device C (F907). The subsequent sequence is the same as the separating process by which the device A separates the device C occurring when anomaly in the device C is detected in the first embodiment. That is, the access control section 115 of the device A having separated the device C from the network registers the MAC address of the device C on the deny MAC address list (F908). The device A having updated the deny MAC address list delivers the deny MAC address list to a subordinate communication device (device B in the present embodiment) from the delivery section 116 (F909).

The access control section 115 of the device B having received the deny MAC address list from the device A updates the deny MAC address list and registers the MAC address of the device being a target for denial of connection on the deny MAC address list (F910). A list receipt notification that the list has been properly received is transmitted (F911).

The network control section 117 of the device A having received the list receipt notification reconstructs the network A (F912). In this network reconstruction, a new network that does not contain the device C is established. Only the deny MAC address list may be simply updated without reconstruction of the network. After that, even if the setting button 106 of the device C is pressed, automatic setting with the network A is not performed.

Here, the registration notification to the infrastructure server (F902, F905) and notification of a result of authentication (F903, F906) can be made during the set-up process or after the completion of the set-up process. In the case where these processes are performed during the set-up process, before a communication parameter is provided to the device B from the device A, which is the management device, the registration notification and authentication result are received. When a notification of acceptance of registration is transmitted from the infrastructure server, a communication parameter automatic setting process (provision from the device A to the device B) is performed by the automatic setting section 118, and the communication parameter is shared by the device A and device B. When the registration is rejected, the set-up process is stopped, and the communication parameter is prohibited from being provided to a rejection target device (device C). At this time, the communication parameter is not provided to the device C, so the rejecting section 119 provides the device C with a notification of rejection of participation to reject participation in the network (F907).

In this way, a communication parameter is provided to a device permitted to participate in the network A by the infrastructure server, whereas it is not provided to a device whose participation is rejected. With this, a communication parameter can be prevented from being provided to a device whose participation is rejected, and network security can be enhanced.

In the case where a registration notification and authentication result are received after the completion of the set-up process, after a communication parameter is provided from the device A to the device B or device C, the registration notification is provided to the infrastructure server. At this time, the communication parameter has been provided to the device C, so the disconnecting section 114 transmits a disconnection notification to the device C to instruct disconnection from the network A (F907). With this, a communication parameter automatic setting process and an authentication process as to participation in a network can be performed independently, so an increase in load in the automatic setting process can be prevented.

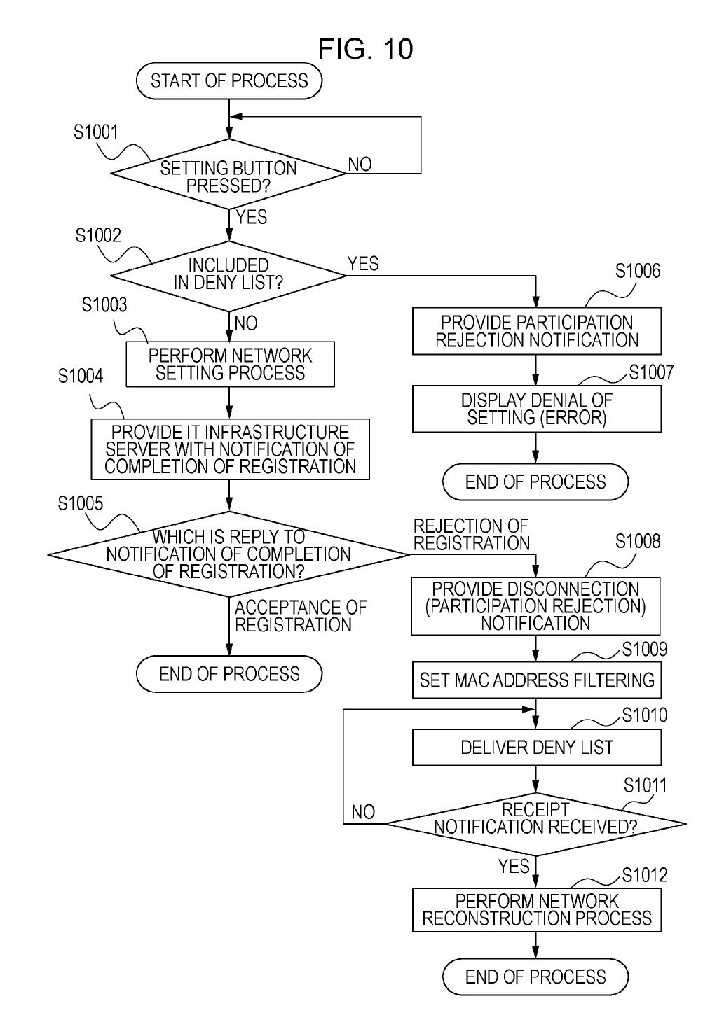

A process by the device A according to the present embodiment is described using FIG. 10. This process is also performed by the control section 102 executing a control program stored in the storage section 103.

The automatic setting section 118 of the device A determines whether the setting button 106 has been pressed (F1001). When a press on the setting button 106 has been detected, a communication partner on which a set-up process is to be performed is searched for. The access control section 115 of the device A determines whether the MAC address of the communication partner detected as a result of the search has been registered on the deny MAC address list retained by the device A (S1002). When the MAC address of the communication partner is not included in the deny MAC address list, the automatic setting section 118 starts a network setting process (set-up process) for performing a process for determining a management device and a process for providing or receiving a communication parameter (S1003). Then, the registration notifying section 120 of the device A transmits a registration notification to the infrastructure server (S1004). There are two methods for performing step S1004: a method of performing it during the network setting process (during the set-up process) and a method of performing it after the completion thereof.

After the transmission of the registration notification, the device A waits for a reply from the infrastructure server (S1005). When the result indicated in the reply is acceptance of registration, the process ends. When step S1004 is performed during the network setting process (during the set-up process), after the receipt of the acceptance of registration, a communication parameter is provided and received by an automatic setting process. When the result indicated in the reply is rejection of registration, the disconnecting section 114 (or rejecting section 119) transmits a disconnection notification (or participation rejection notification) to the communication partner (S1008). When step S1004 is performed during the network setting process (during the set-up process), the rejecting section 119 provides the notification of rejection of participation; when step S1004 is performed after the completion of the network setting process (during the set-up process), the disconnecting section 114 provides the notification of disconnection. Then, the MAC address of the communication partner is registered on the deny MAC address list (S1009).

After the registration on the deny MAC address list, the delivery section 116 delivers the list to a subordinate communication device (S1010). After the delivery of the deny MAC address list, the device A waits for a receipt notification from all communication devices to which the list was delivered (S1011). When the receipt notification is received from all the communication devices, the network is reconstructed (S1012), and the process ends. When not all receipt notifications have been received from the communication devices, the deny MAC address list is delivered again.

When the MAC address of the communication partner is included in the deny MAC address list in step S1002, the rejecting section 119 transmits a participation rejection notification of rejection of participation in the network to the partner device (S1006). The transmission of the participation rejection notification disables a communication parameter automatic setting process with the partner. Then, the rejecting section 119 displays denial of setting (error) on the display section 105 to notify a user of denial of execution of the automatic setting (S1007).

In the description so far, a configuration in which the device A provides the infrastructure server with a registration notification during a set-up process or after the completion of a set-up process is described. Other than this configuration, the device A may notify the infrastructure server of information about a subordinate communication device on a regular basis. With such a configuration, a case in which there is a communication device that temporarily exits from a network and a case in which a network connection policy is changed after the completion of connection to the network can be supported.

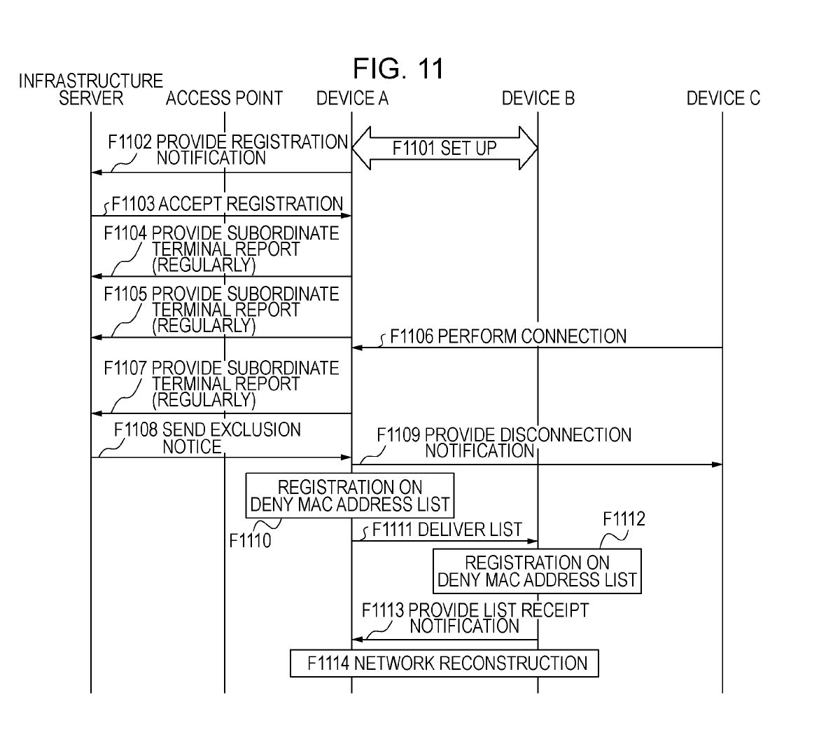

A sequence for this configuration is illustrated in FIG. 11. The setting button 106 of each of the device A and device B is pressed. This causes a wireless LAN set-up process to be performed between the device A and device B (F1101). During the set-up process or after the completion of the set-up process, the device A transmits a registration notification to the infrastructure server to notify the infrastructure server of existence of a communication device that attempts to newly participate in the network A (F1102). The infrastructure server having received the registration notification (F1102) determines on the basis of a network policy retained by the infrastructure server whether the device B is permitted to participate in the network A or not. When determining to accept participation by the device B in the network, the infrastructure server transmits a notification of acceptance of registration toward the device A (F1103). Because the device A is determined in advance to operate as a management device for the network A, after the completion of the set-up, the device B becomes connected to the device A. To report a condition of a subordinate communication device to the infrastructure server, the device A regularly transmits a subordinate terminal report (F1104 and F1105).

Here, a case in which the device C that does not perform set-up and that coincidentally has the same communication parameter connects itself to the network A is discussed. It is assumed that the device C is a device that opposes a network management policy of the infrastructure server.

The device C connects itself to the device A (F1106). Because the device C connects itself to the device A, the device A reports the existence of the device C in the next periodical report to the IT infrastructure server (F1107). The infrastructure server having received the subordinate terminal report of F1107 transmits an exclusion notice to the device A because the device C opposes the network policy (F1108). The disconnecting section 114 of the device A having received the exclusion notice F1108 transmits a disconnection notification toward the device C (F1109). The subsequent sequence is the same as the separating process by which the device A separates the device C occurring when anomaly in the device C is detected in the first embodiment. That is, the device A having separated the device C from the network registers the MAC address of the device C on the deny MAC address list (F1110). The device A having updated the deny MAC address list delivers the deny MAC address list to a subordinate communication device (device B in the present embodiment) (F1111).

The device B having received the deny MAC address list from the device A updates the deny MAC address list (F1112) and transmits a list receipt notification that the list has been properly received (F1113).

The device A having received the list receipt notification reconstructs the network A (F1114). At this time, the device A and device B establish a new network that does not contain the device C. However, depending on the case, the deny MAC address list may be updated without reconstruction of the network.

With FIG. 11, the device C coincidentally has the same communication parameter as that of the network A. Other than this situation, a case in which the device A and device C perform a set-up process in advance, and the device C temporarily exits from the network A, and the network polity retained by the infrastructure server is changed during that exit period can also be described using a similar sequence.

In addition, in a case where, although connection of all communication devices is accepted at the time of the set-up, the network policy of the infrastructure server is changed after the completion of the connection, a communication device that opposes the network policy may appear. Also in such a case, the process can also be described using the operational sequence described with FIG. 11.

As described above, with the present embodiment, a communication device that can participate in the network A can be controlled on the basis of a network policy retained by the infrastructure server.

### Third Embodiment

For the first embodiment, a case in which a network management device (device A in the first embodiment) detects anomaly in a network connection device (device C in the first embodiment) and excludes it from the network is described. For the third embodiment, behavior occurring in a case where a network connection device (here, device C) detects anomaly in a network management device (here, device A) is described.

Communication devices have the configuration illustrated in FIG. 1, as in the case of the first embodiment and second embodiment. The network configuration is assumed to be the configuration illustrated in FIG. 2, as in the case of the first embodiment.

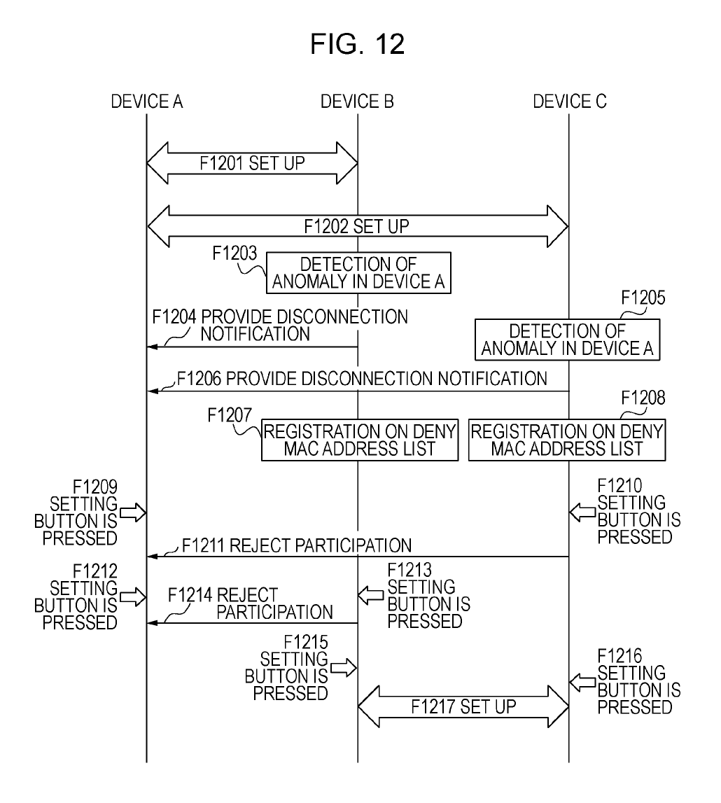

FIG. 12 is a sequence diagram that illustrates an example in which the setting button 106 of each of the device A, device B, and device C is pressed, an automatic setting process is performed between the devices, the devices are connected to each other, and then, a problem occurs in the device A and the devices B and C separate the device A.

When the setting button 106 of each of the device A and device B is pressed, a wireless LAN set-up process is performed between the device A and device B (F1201). In the set-up process, the device A is determined to operate as a management device for the network A. Accordingly, after the completion of the set-up, the device B becomes connected to the device A.

A wireless LAN set-up process is performed between the device A and device C (F1202). After the completion of the set-up, the device C becomes connected to the device A, as in the case of the device A and the device B. While the device A and device C are performing the set-up, the device B can communicate with the device A.

After the network A is constructed from the device A, device B, and device C, the device B and device C detect anomaly in the device A (F1203, F1205). The definition of anomaly here is equivalent to that described in the first embodiment. The device B having detected anomaly in the device A transmits a disconnection notification to end the connection to the device A (F1204). Similarly, the device C also transmits a disconnection notification to toward the device A (F1206). Each of the device B and device B having separated the device A from the network A registers the MAC address of the device A on the deny MAC address list (F1207, F1208).

With the above-described operation, the device B and device C exit from the network A. Here, when the setting button 106 of each of the device A and device C is pressed (F1209, F1210), a participation rejection notification is transmitted from the device C to the device A and set-up is not performed (F1211). Similarly, also when the setting button 106 of each of the device A and device B is pressed (F1212, F1213), a participation rejection notification is transmitted from the device B to the device A (F1214).

When the setting button 106 of each of the device B and device C is pressed, a set-up process is performed between the device B and device C (F1217), and a new network is established.

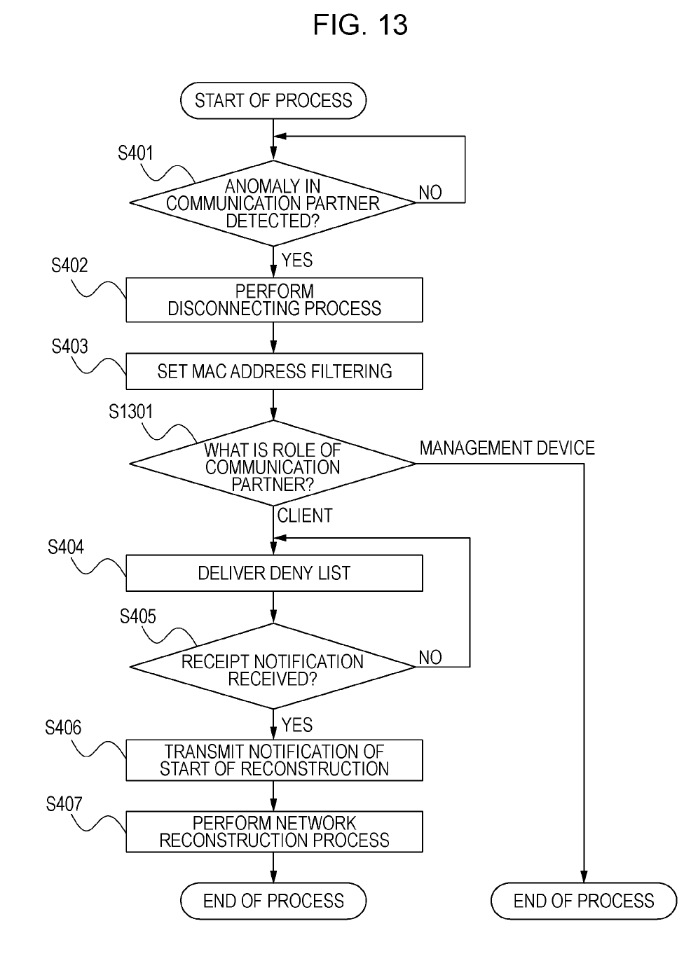

A process by the devices B and C is described using FIG. 13. The process illustrated in FIG. 13 is also performed by the control section 102 of each of the devices B and C executing a control program stored in the storage section 103. FIG. 13 is the one in which a new determination step S1301 is added between step S403 and step S404 of FIG. 5.

A process by a communication device is described on the basis of FIG. 13. In this flow diagram, wireless LAN set-up is omitted. That is, FIG. 13 is an operational flow diagram that illustrates F1203 and its subsequent operations illustrated in FIG. 12.

It is determined whether a communication device has detected anomaly in a communication partner (S401). When anomaly has been detected in S401, a disconnection notification is transmitted to the communication partner (S402). After that, the MAC address of the disconnected communication device is registered on the deny MAC address list, and MAC address filtering is performed (S403).

Here, it is determined whether the role of the communication device being the communication partner is a network connection device (client) or a network management device (S1301).

As a result of the determination, when it is a client, the same process as in step S404 and its subsequent steps illustrated in FIG. 5 is performed. When it is determined in the determining process in step S1301 that the role of the communication device being the communication partner is a management device, the process ends at this point.

As described above, irrespective of the role of a communication device (management device or client), participation in a network can be controlled on the basis of a network policy or behavior.

The management device in the foregoing description may be an access point. In this case, a management device is determined between devices, and the device determined as the management device operates as the access point and establishes a network. It performs an operation as the management device described in the above embodiments.

The foregoing description describes an IEEE 802.11 compliant wireless LAN as an example. However, the present invention may be made with another wireless medium, such as a wireless USB, MBOA, Bluetooth (registered trademark), UWB, and ZigBee. It may be made with a wired communication medium, such as the one using wired LAN.

Here, MBOA is an abbreviation for Multi Band OFDM Alliance. UWB includes a wireless USB, wireless 1394, and WINET.

A network identifier, an encryption method, an encryption key, an authentication method, or an authentication key is used as an example of a communication parameter. The communication parameter may be another information, and it is needless to say that other kinds of information may be contained in the communication parameter.

According to the present invention, a device that is a target for denial of communication can be shared over a network, and communication with a denial target device can be prevented.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A communication device comprising:
a registering unit that registers identifying information of a denial target device that is present in a first network and that is a target for denial of communication;
a notifying unit that notifies another device present in the first network of the identifying information of the denial target device registered by the registering unit; and
a constructing unit that constructs, with the other device, a second network different from the first network in which the denial target device is present.

2. The communication device according to claim 1, further comprising:
a sharing unit that performs a sharing process to share by the devices a communication parameter for constructing a network,
wherein the constructing unit executes the sharing process by the sharing unit with the other device to construct the second network.

3. The communication device according to claim 2, wherein the sharing unit executes a process required for providing or receiving the communication parameter.

4. The communication device according to claim 1, wherein the constructing unit constructs the second network using any of a plurality of network information elements shared in constructing the first network.

5. The communication device according to claim 4, further comprising:
a specifying unit that specifies any of the plurality of network information elements,
wherein the constructing unit constructs the second network using the network information element specified by the specifying unit.

6. The communication device according to claim 1, further comprising:
a sharing unit that performs a sharing process to share by devices a communication parameter for constructing a network,
wherein the sharing unit executes the sharing process depending on whether a communication partner on which the sharing process is to be performed is a device registered as a denial target device by the registering unit.

7. The communication device according to claim 1, further comprising:
a disconnecting unit that disconnects connection to a device registered as a denial target device by the registering unit.

8. The communication device according to claim 1, wherein the registering unit registers, as a denial target device, a device in which anomaly is detected by the communication device.

9. The communication device according to claim 1, wherein the registering unit identifies a denial target device in response to a result of authentication performed by an authentication device and registers the identified device as a denial target device.

10. A communication device comprising:
a registering unit that registers identifying information of a denial target device that is a target for denial of communication;
a notifying unit that notifies another device of the identifying information of the denial target device registered by the registering unit;
a sharing unit that performs a sharing process to share by devices communication parameter for constructing a network; and
a determining unit that determines whether the sharing process is to be executed, depending on whether a communication partner on which the sharing process is to be performed is a device registered as a denial target device by the registering unit,
wherein the sharing unit executes the sharing process in response to the determination by the determining unit.

11. A control method for a communication device, the control method comprising:
a registering step of registering identifying information of a denial target device that is present in a first network and that is a target for denial of communication;
a notifying step of notifying another device present in the first network of the identifying information of the denial target device registered in the registering step; and
a constructing step of constructing, with the other device, a second network different from the first network in which the denial target device is present.

12. A control method for a communication device, the control method comprising:
a registering step of registering identifying information of a denial target device that is a target for denial of communication;
a notifying step of notifying another device of the identifying information of the denial target device registered in the registering step;
a sharing step of performing a sharing process to share by devices a communication parameter for constructing a network; and
a determining step of determining whether the sharing process is to be executed, depending on whether a communication partner on which the sharing process is to be performed is a device registered as a denial target device in the registering step,
wherein the sharing step executes the sharing process in response to the determination in the determining step.

13. A computer readable storage medium storing a computer program code for causing a computer to execute the communication method set forth in claim 11.

14. A computer readable storage medium storing a computer program code for causing a computer to execute the communication method set forth in claim 12.
